(19) United States
(12) Patent Application Publication
(10) Pub. No.: US 2025/0180498 A1
(43) Pub. Date: Jun. 5, 2025

(54) THERMAL RESISTANCE MEASUREMENT RESULT UNIFORMIZATION DEVICE FOR HEAT DISSIPATION MODULE

(71) Applicant: Long Victory Instruments Co., Ltd., Taoyuan City (TW)

(72) Inventor: Chien-Chung FENG, Taoyuan City (TW)

(21) Appl. No.: 18/528,365

(22) Filed: Dec. 4, 2023

(51) Int. Cl. G01N 25/18

(52) U.S. Cl. CPC G01N 25/18

(57) ABSTRACT

A thermal resistance measurement result uniformization device for a heat dissipation module, including: a control unit for storing an executable thermal resistance measurement logic; a wind tunnel having a casing, a wind tunnel blower and a flow rate measurement unit, allowing air flow rate inside the wind tunnel to be fixed; a heater attached to a heat dissipation module under test and having a fixed heating power; a heating sensor for sensing the temperature of the heater block; and an environment sensor for sensing ambient temperature, relative humidity and atmospheric pressure. The thermal resistance measurement logic has equations, namely

$${R}_{CVT} = R \times \frac{h}{{h}_{STP}} , and h = \frac{W}{A Δ T} , Δ T = {T}_{C} - {T}_{A} , and R = \frac{Δ T}{W} ,$$

and calculates converted thermal resistance with the equations. The control unit executes the thermal resistance measurement logic to obtain the converted thermal resistance of the heat dissipation module under test.

### BACKGROUND OF THE INVENTION

### 1. Field of the Invention

The present disclosure relates to thermal resistance measurement technology applicable to heat dissipation modules, and more particularly to a thermal resistance measurement result uniformization device for a heat dissipation module.

### 2. Description of Related Art

Taiwan invention U.S. Pat. No. 1,315,399 discloses a system and method of measuring LED junction temperature and thermal resistance. Taiwan invention U.S. Pat. No. 1,315,399 is aimed at measuring the thermal resistance of LEDs and addressing the issue with excessive measurement errors resulting from the inadequate importance attached to the light output power of LEDs during a conventional measurement process.

Conventional thermal resistance measurement techniques applicable to existing heat dissipation modules, such as a finned heat sink and a fin-equipped heat pipe, entail measuring the heat dissipation modules directly but do not give considerations to errors arising from the differences between measurement locations. Thus, the result of measuring the same heat dissipation module varies from location to location and from altitude to altitude. As a result, a transaction dispute between a heat dissipation module manufacturer and a buyer is likely to occur because of a location-induced difference in the measured thermal resistance between the manufacturer and the complaining buyer.

At present, there is not any heat dissipation module thermal resistance measurement technique effective in overcoming the aforesaid drawback of the prior art, i.e., the result of measuring the same heat dissipation module varies from location to location.

### BRIEF SUMMARY OF THE INVENTION

The disclosure is aimed at overcoming the aforesaid drawback of the prior art, i.e., the result of measuring the same heat dissipation module varies from location to location.

It is an objective of the disclosure to provide a thermal resistance measurement result uniformization device for a heat dissipation module to allow the measured thermal resistance of a heat dissipation module under test operating in any environment to be converted into a converted thermal resistance that approximates to the thermal resistance at standard temperature and pressure of the heat dissipation module under test, with a difference of less than 1%, rendering the converted thermal resistance nearly invariable wherever the measurement process takes place.

To achieve the above and other objectives, the disclosure provides a thermal resistance measurement result uniformization device for a heat dissipation module, comprising: a control unit for storing an executable thermal resistance measurement logic; a wind tunnel having a casing, a wind tunnel blower and a flow rate measurement unit, the wind tunnel blower being electrically connected to the control unit and controlled by the control unit to drive movement of air inside the wind tunnel, and the flow rate measurement unit being electrically connected to the control unit to sense a flow rate of the air inside the wind tunnel, with the flow rate being kept invariable by the wind tunnel blower; a heater being disposed at the casing of the wind tunnel, having a heating block adapted to be attached to a heat dissipation module under test positioned on a path of the movement of the air through the wind tunnel, and being electrically connected to the control unit to be controlled by the control unit to heat the heat dissipation module under test, wherein a forced convection coefficient at standard temperature and pressure of the heat dissipation module under test is known, and the heater has a fixed heating power for heating the heat dissipation module under test; a heating sensor disposed at the heating block and electrically connected to the control unit to sense a temperature of the heating block, allowing its sensing result to be read by the control unit; and an environment sensor electrically connected to the control unit to sense ambient temperature, relative humidity and atmospheric pressure outside the wind tunnel, allowing its sensing result to be read by the control unit, wherein the thermal resistance measurement logic comprises: a relation of thermal resistance and forced convection coefficient:

$${R}_{CVT} = R \times \frac{h}{{h}_{STP}} ,$$

and a forced convection coefficient equation:

$$h = \frac{W}{A Δ T} , Δ T = {T}_{C} - {T}_{A} ,$$

and an equation of thermal resistance and power:

$$R = \frac{Δ T}{W} ,$$

converted thermal resistance R_{CVT} is calculated according to the equations, wherein R denotes thermal resistance, h denotes forced convection coefficient, h_{STP} denotes forced convection coefficient at standard temperature and pressure, W denotes the heater's power of heat generation, A denotes heat dissipation area of the heat dissipation module under test, T_{C} denotes temperature sensed by the heating sensor, T_{A} denotes temperature sensed by the environment sensor, and R_{CVT} denotes converted thermal resistance, wherein the control unit executes the thermal resistance measurement logic to obtain converted thermal resistance of the heat dissipation module under test.

Therefore, the disclosure is effective in rendering the converted thermal resistance nearly invariable, with a difference of less than 1%, wherever the measurement process takes place, so as to overcome the aforesaid drawback of the prior art.

### BRIEF DESCRIPTION OF THE SEVERAL VIEWS OF THE DRAWINGS

FIG. 1 is a block diagram of a thermal resistance measurement result uniformization device according to a preferred embodiment of the disclosure.

FIG. 2 is a perspective view of part of the thermal resistance measurement result uniformization device according to a preferred embodiment of the disclosure.

FIG. 3 schematically depicts measurement results according to a preferred embodiment of the disclosure.

### DETAILED DESCRIPTION OF THE INVENTION

Technical features of the disclosure are herein illustrated with preferred embodiments, depicted with drawings, and described below.

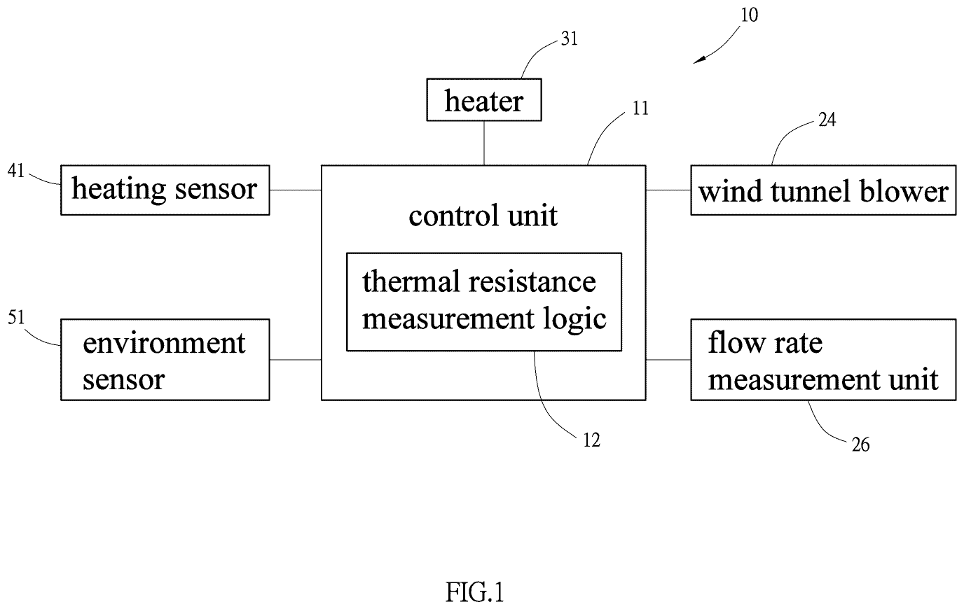

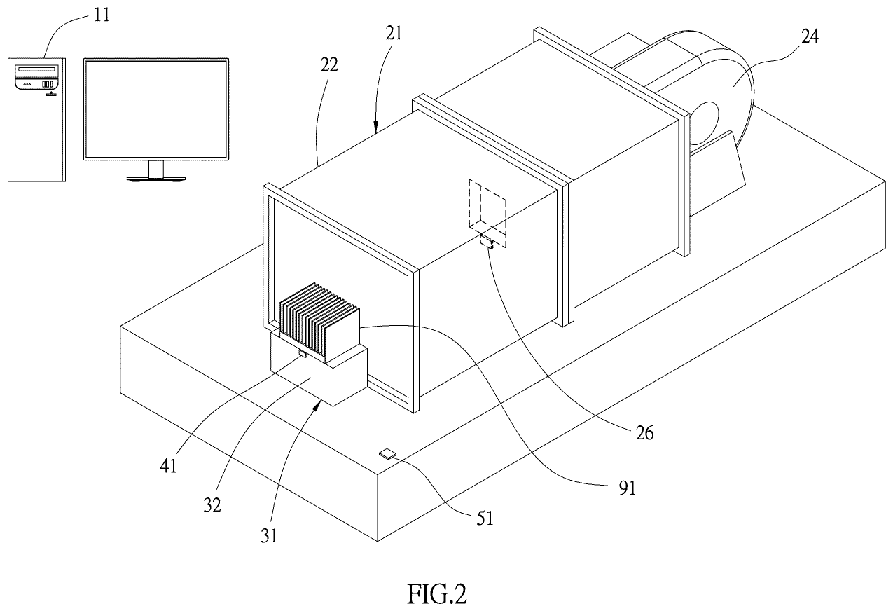

As shown in FIG. 1 and FIG. 2, a preferred embodiment of the disclosure provides a thermal resistance measurement result uniformization device 10 for a heat dissipation module, essentially comprising a control unit 11, a wind tunnel 21, a heater 31, a heating sensor 41 and an environment sensor 51.

The control unit 11 stores an executable thermal resistance measurement logic 12. In this embodiment, the control unit 11 is a computer, a microcomputer, one single chip or any other known control system. In this embodiment, the control unit 11 is exemplified by a computer.

The wind tunnel 21 has a casing 22, a wind tunnel blower 24 and a flow rate measurement unit 26. The wind tunnel blower 24 is electrically connected to the control unit 11 and controlled by the control unit 11 to drive the movement of the air inside the wind tunnel 21. The flow rate measurement unit 26 is electrically connected to the control unit 11 to sense the air flow rate inside the wind tunnel 21. The wind tunnel blower 24 is controlled by the control unit 11 to drive the movement of the air and keep the air flow rate inside the wind tunnel 21 invariable. Maintaining a fixed air flow rate is conducive to the elimination of a variable (i.e., the air flow rate) in a measurement process.

The heater 31 is disposed at the casing 22 of the wind tunnel 21. The heater 31 has a heating block 32. The heating block 32 is adapted to be attached to a heat dissipation module under test 91. The heat dissipation module under test 91 is positioned on the path of the movement of the air through the wind tunnel 21. The heater 31 is electrically connected to the control unit 11 and controlled by the control unit 11 to heat up the heat dissipation module under test 91. The forced convection coefficient at standard temperature and pressure h_{STP} of the heat dissipation module under test 91 is known. The heater 31 is configured to have a fixed heating power during its heating process, because maintaining a fixed heating power is conducive to the elimination of a variable (i.e., the heating power) in a measurement process. The forced convection coefficient at standard temperature and pressure h_{STP} are obtained by a manufacturer that performs a measurement process on the heat dissipation module under test 91 before its delivery at an ambient temperature of 20° C., a relative humidity of 50%, and an atmospheric pressure of 1 atm. In this embodiment, the heat dissipation module under test 91 is exemplified by a multi-finned heat sink.

The heating sensor 41 is disposed at the heating block 32 and electrically connected to the control unit 11. The heating sensor 41 senses the temperature of the heating block 32, allowing its sensing result to be read by the control unit 11.

The environment sensor 51 is electrically connected to the control unit 11 to sense the ambient temperature, relative humidity and atmospheric pressure outside the wind tunnel 21, allowing its sensing result to be read by the control unit 11. In this embodiment, the environment sensor 51 senses the room temperature and thus is on a machine table outside the wind tunnel 21 instead of inside the wind tunnel 21.

The thermal resistance measurement logic 12 comprises the following:

A relation of thermal resistance and forced convection coefficient:

$${R}_{CVT} = R \times \frac{h}{{h}_{STP}} ;$$

a forced convection coefficient equation

$$h = \frac{W}{A Δ T} , Δ T = {T}_{C} - {T}_{A} ;$$

and an equation of thermal resistance and power:

$$R = \frac{Δ T}{W} ,$$

converted thermal resistance R_{CVT} is calculated according to the equations.

R denotes thermal resistance, h denotes forced convection coefficient, h_{STP} denotes forced convection coefficient at standard temperature and pressure, W denotes the power of the heater 31 while it is generating heat, A denotes the heat dissipation area of the heat dissipation module under test 91 (and denotes the area of fins when the heat dissipation module under test 91 has fins), T_{C} denotes the temperature sensed by the heating sensor 41, T_{A} denotes the temperature sensed by the environment sensor 51, and R_{CVT} denotes converted thermal resistance.

The control unit 11 executes the thermal resistance measurement logic 12 to obtain the converted thermal resistance R_{CVT} of the heat dissipation module under test 91.

The framework of this embodiment is described above. This embodiment is implemented as explained below.

As shown in FIG. 2, prior to a measurement process to be performed on it, the heat dissipation module under test 91 is placed on the heating block 32 of the heater 31 such that the heat dissipation module under test 91 is positioned on the path of the movement of the air through the wind tunnel 21 to remove heat and thus achieve heat dissipation. After that, the wind tunnel blower 24 is started to drive the movement of the air inside the wind tunnel 21, and the heater 31 is started to heat up the heat dissipation module under test 91.

As shown in FIG. 1 through FIG. 3, when the measurement process begins, the control unit 11 executes the thermal resistance measurement logic 12 to thereby read temperature T_{C} sensed by the heating sensor 41 and temperature T_{A} sensed by the environment sensor 51. Next, the forced convection coefficient h of the heat dissipation module under test 91 is calculated with the equation

$$h = \frac{W}{A Δ T} , Δ T = {T}_{C} - {T}_{A} ,$$

the heat generation power W of the heater 31, and the heat dissipation area A of the heat dissipation module under test 91.

Then, the thermal resistance R of the heat dissipation module under test 91 is calculated with the equation

$$R = \frac{Δ T}{W} ,$$

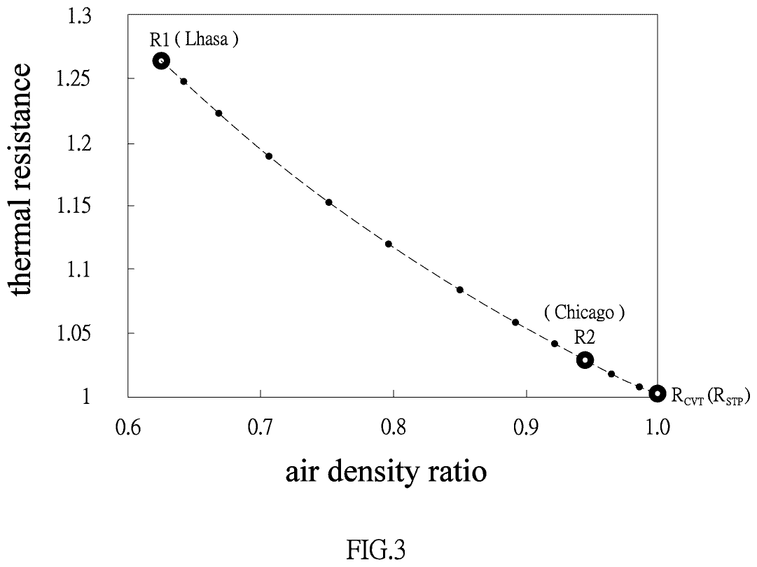

and the thermal resistance R thus calculated is the thermal resistance measured at a current location. As shown in FIG. 3, thermal resistance R1 measured in Lhasa is different from thermal resistance R2 measured in Chicago. In addition, it can be directly understood that the thermal resistance R can also be obtained from previously measured data and is not limited to current location measurements.

Next, the converted thermal resistance R_{CVT} is calculated with the equation

$${R}_{CVT} = R \times \frac{h}{{h}_{STP}} .$$

As shown in FIG. 3, the converted thermal resistances R_{CVT} obtained by conversion with the two thermal resistances R1, R2 are equal and overlap each other in terms of their numeral values.

Given the known equations W=hAΔT=h_{STP}AΔT_{STP}=W_{STP}, and an invariable heating power, the equation hAR=h_{STP}AR_{STP} is inferred from the equation

$$R = \frac{Δ T}{W} ,$$

resulting in the equation hR=h_{STP}R_{STP}; thus, it can be confirmed that the converted thermal resistance R_{CVT} is almost equal to the thermal resistance at standard temperature and pressure R_{STP} of the heat dissipation module under test 91. The result shown in FIG. 3 suggests that the resultant converted thermal resistance R_{CVT} nearly overlaps the thermal resistance at standard temperature and pressure R_{STP}, with an error of 1% or less.

Therefore, according to the disclosure, although the measured thermal resistance of the heat dissipation module under test 91 varies from location to location, the converted thermal resistance R_{CVT} of the heat dissipation module under test 91 can be calculated with the forced convection coefficient h and forced convection coefficient at standard temperature and pressure h_{STP} of the heat dissipation module under test 91 such that the calculated converted thermal resistance R_{CVT} of the heat dissipation module under test 91 is almost equal to the thermal resistance at standard temperature and pressure R_{STP}, with a difference of 1% or less, wherever the measurement process is performed on the heat dissipation module under test 91, overcoming the aforesaid drawback of the prior art.

What is claimed is:

1. A thermal resistance measurement result uniformization device for a heat dissipation module, comprising:
a control unit for storing an executable thermal resistance measurement logic;
a wind tunnel having a casing, a wind tunnel blower and a flow rate measurement unit, the wind tunnel blower being electrically connected to the control unit and controlled by the control unit to drive movement of air inside the wind tunnel, and the flow rate measurement unit being electrically connected to the control unit to sense a flow rate of the air inside the wind tunnel, with the flow rate being kept invariable by the wind tunnel blower;
a heater being disposed at the casing of the wind tunnel, having a heating block adapted to be attached to a heat dissipation module under test positioned on a path of the movement of the air through the wind tunnel, and being electrically connected to the control unit to be controlled by the control unit to heat the heat dissipation module under test, wherein a forced convection coefficient at standard temperature and pressure of the heat dissipation module under test is known, and the heater has a fixed heating power for heating the heat dissipation module under test;
a heating sensor disposed at the heating block and electrically connected to the control unit to sense a temperature of the heating block, allowing its sensing result to be read by the control unit; and
an environment sensor electrically connected to the control unit to sense ambient temperature, relative humidity and atmospheric pressure outside the wind tunnel, allowing its sensing result to be read by the control unit,
wherein the thermal resistance measurement logic comprises:
a relation of thermal resistance and forced convection coefficient:
$${R}_{CVT} = R \times \frac{h}{{h}_{STP}} ,$$
and
a forced convection coefficient equation:
$$h = \frac{W}{A Δ T} , Δ T = {T}_{C} - {T}_{A} ,$$
and
an equation of thermal resistance and power:
$$R = \frac{Δ T}{W} ,$$
converted thermal resistance R_{CVT} is calculated according to the equations,
wherein R denotes thermal resistance, h denotes forced convection coefficient, h_{STP} denotes forced convection coefficient at standard temperature and pressure, W denotes the heater's power of heat generation, A denotes heat dissipation area of the heat dissipation module under test, T_{C} denotes temperature sensed by the heating sensor, T_{A} denotes temperature sensed by the environment sensor, and R_{CVT} denotes converted thermal resistance,
wherein the control unit executes the thermal resistance measurement logic to obtain converted thermal resistance of the heat dissipation module under test.

2. The thermal resistance measurement result uniformization device for a heat dissipation module according to claim 1, wherein the forced convection coefficient at standard temperature and pressure is obtained by performing measurement on the heat dissipation module under test at an ambient temperature of 20° C., a relative humidity of 50%, and an atmospheric pressure of 1 atm.

3. The thermal resistance measurement result uniformization device for a heat dissipation module according to claim 1, wherein the control unit is a computer.

4. The thermal resistance measurement result uniformization device for a heat dissipation module according to claim 1, wherein the environment sensor is not inside the wind tunnel.
